(19) United States
(12) Patent Application Publication
(10) Pub. No.: US 2026/0064397 A1
(43) Pub. Date: Mar. 5, 2026

(54) REMOTE DISK REIMAGING TECHNIQUES

(71) Applicant: Schlumberger Technology Corporation, Sugar Land, TX (US)

(72) Inventor: Bruno Augusto Branco Mazetti

(21) Appl. No.: 18/822,366

(22) Filed: Sep. 2, 2024

(51) Int. Cl. G06F 8/61; G06F 8/654

(52) U.S. Cl. CPC G06F 8/63; G06F 8/654

(57) ABSTRACT

A method includes receiving a reimaging package. The method also includes loading the reimaging package to a non-volatile memory of a computing system that stores a first disk in the volatile memory. Further, the method includes adjusting a firmware of the computing system based on the reimaging package. Further still, the method also includes performing a power cycle of the computing system based on the adjusted firmware. Even further, the method includes loading the reimaging package to a volatile memory of the computing system after the first power cycle. Even further, the method includes reimaging the computing system based on the reimaging package loaded to the volatile memory of the computing system.

### BACKGROUND

The present disclosure relates generally to managing computing systems, and more specifically, to reimaging computing systems.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Oil and gas operations utilize computing systems in a variety of environments, many of which are remote locations that are difficult to access or otherwise not readily accessible. For example, a wellsite may be located in a jungle, on an island, out in the ocean, or otherwise in an area without access to infrastructure or modes of transportation. Updating the operating system or reimaging the computing systems may be financially costly due to the difficulty in sending an operator to the remote location.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

One aspect of the present disclosure relates to a method. The method includes a reimaging package, wherein the reimaging package includes an identical storage image of optical media (ISO) file. The method also includes receiving the reimaging package to a non-volatile memory of a computing system that stores a first disk in the volatile memory based on the reimaging package. Further, the method includes adjusting a firmware of the computing system based on the preparation script. Further still, the method includes performing a first power cycle of the computing system based on the reimaging package. Even further, the method includes loading the reimaging package to a volatile memory of the computing system after the power cycle. Even further, the method includes reimaging the computing system based on the ISO file loaded to the volatile memory of the computing system. Even further, the method includes adjusting the firmware of the computing system based on ISO file, subsequent to reimaging the computing system. Even further, the method includes performing a second power cycle of the computing system.

Another aspect of the present disclosure relates to a system. The system includes a first computing system that transmits a reimaging package. The system also includes a second computing system comprising a processor. The computing system is configured to receive a reimaging package, wherein the reimaging package includes an identical storage image of optical media (ISO) file. The computing system is also configured to load the reimaging package to a non-volatile memory of a computing system that stores a first disk in the volatile memory based on the reimaging package. Further, the computing system is configured to adjust a firmware of the computing system based on the preparation script. Further still, the computing system is configured to perform a first power cycle of the computing system based on the reimaging package. Even further, the computing system is configured to load the reimaging package to a volatile memory of the computing system after the power cycle. Even further, the computing system is configured to reimage the computing system based on the ISO file loaded to the volatile memory of the computing system. Even further, the computing system is configured to adjust the firmware of the computing system based on ISO file, subsequent to reimaging the computing system. Even further, the computing system is configured to perform a second power cycle of the computing system.

Another aspect of the present disclosure relates to a method. The method includes generating an ISO file comprising an ISO preparation script, a new system content, and an ISO boot script. The method also includes generating a preparation script, wherein the preparation script is configured to modify a boot order of a computing system, and wherein the preparation script is configured to cause the computing system to load the ISO file to a non-volatile memory of the computing system. Further, the method includes assembling the ISO file and the preparation script to form a reimaging package.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic diagram of a disk reimaging system in communication with multiple computing systems via a network, according to one or more embodiments of this disclosure;

FIG. 2 illustrates a block diagram of various components that may be part of the disk reimaging system and the computing systems, according to one or more embodiments of this disclosure;

FIG. 3 illustrates a block diagram of a reimaging package, according to one or more embodiments of this disclosure;

FIG. 4 is a flow diagram of an example method for reimaging a disk in accordance with the present disclosure, according to one or more embodiments of this disclosure; and

FIG. 5 shows a block diagram of a computing system under going disk reimaging, according to one or more embodiments of this disclosure.

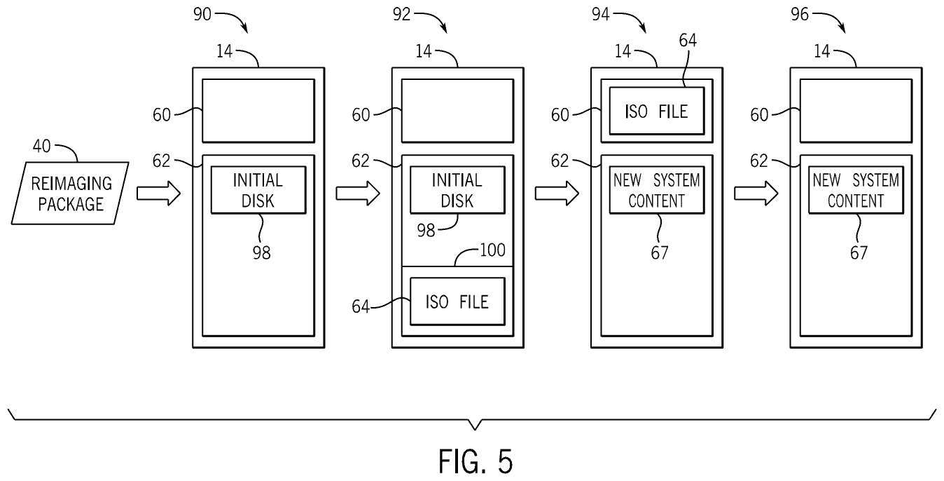

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As discussed above, reimaging disks of computing systems in remote locations is a costly endeavor. In conventional techniques, an operator must physically access the computing systems (e.g., gateway computing systems) and manually perform the reimaging. The imposes significant demands on the operations team as manual disk reimaging consumes substantial time and resources, leading to increased operational costs and inefficiencies for the company. With many gateways currently deployed in the field, the manual process creates delays and acts as a significant bottleneck for software and application teams who need to reimage the computing system OS (e.g., a gateway OS).

Accordingly, the present disclosure relates to remote reimaging techniques that facilitate reimaging even without an operator being physically present at the location where the disk is being reimaged. In general, the disclosed techniques include generating and/or utilizing a reimaging package that includes a preparation script and an optical disc image file (e.g., an identical storage image of optical media (ISO) file). In general, the preparation script causes the ISO file to be loaded onto a non-volatile memory computing system (e.g., a target computing system). The preparation script may include instructions that cause the computing system to generate a new partition to load the optical disk image to. Further, the preparation script includes instructions that modify a boot order on the basic input/output system (BIOS) of the computing system. In particular, the preparation script causes the computing system to boot the new partition first, thereby executing scripts or software files stored on the new partition. The ISO file includes an ISO preparation script, new system content, and an ISO boot script. The ISO preparation script causes the computing device to load the ISO boot script to the volatile memory (e.g., random access memory (RAM)) of the computing system. Accordingly, the computing device may reimage the non-volatile memory of the computing system to include the new system content (e.g., new operating system). The ISO boot script causes the computing system to modify the boot order of the BIOS of the computing such that the reimaged disk (e.g., new system including the new system content) is loaded first. Further, the ISO boot script causes the computing system to power cycle, thereby completing reimaging of the disk. In this way, the computing system may be reimaged in a manner that can be performed without an operator being physically present. After the disk is reimaged, a remote operator or technician can have remote access to control operations of the computing system. Further, by writing the ISO file to the volatile memory, the computing system may not include any trace of the reimaging being performed. Accordingly, the computing system looks the same as a reimaged computing device that was reimaged by a physically present operator.

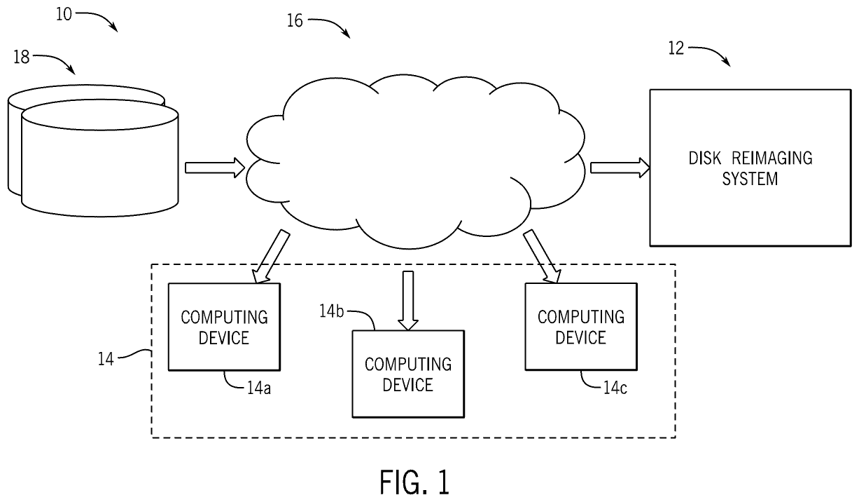

With the foregoing in mind, FIG. 1 illustrates a schematic diagram of a system 10 that includes a disk reimaging system 12 in communication with multiple computing systems 14a, 14b, and 14c (e.g., collectively computing systems 14) and a database 18 via a network 16. In general, the disk reimaging system 12 monitors and maintains disk reimaging for the computing systems. For example, the disk reimaging system may transmit a reimaging package that facilitates remote disk reimaging as discussed above. The computing systems 14 may include desktop computers, gateways, laptops, tablets, and the like. Further, the computing systems 14 may be capable of sending control signals that control operation at a wellsite or other oil and gas related location. For example, the computing system 14 may control a drill, may manage telecommunications, communicate with downhole tools, and so on.

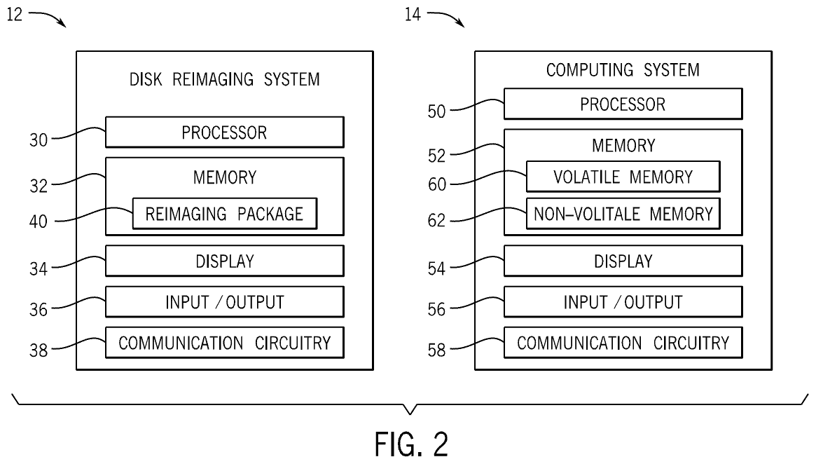

To perform the operations described herein, the disk reimaging system 12 and the computing systems 14 may include one or more hardware elements (including circuitry), software elements (including machine-executable instructions) or a combination of both hardware and software elements (which may be referred to as logic). FIG. 2 is a block diagram illustrating the disk reimaging system 12 and the computing systems 14, in accordance with aspects of the present disclosure. It should be noted that FIG. 2 is merely one example of a particular implementation and is intended to illustrate the types of components that may be present in disk reimaging system 12 and the computing systems 14.

The disk reimaging system 12 may include a processor 30, a memory 32, a display 34, input/output components (I/O) 36, and communication circuitry 38 to enable the disk reimaging system 12 to communicate with external computing systems 14, other computing systems, and external storage components, such as cloud storage or the database 18. In some embodiments, the data discovery and transformation system 12 may store and/or execute an application in the memory 32 to be executed by the processor 30 that facilitates communication with the database 18. In some embodiments, the processor 30 may be one or more processors.

The communication circuitry 38 may include, for example, communication circuitry for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on.

As shown, the memory 32 of the disk reimaging system 12 includes a reimaging package 40. In general, the reimaging package 40 is a software file that stores instructions and information to update an operating system of a computing system 14. As described above, the reimaging package 40 includes a preparation script and an ISO file. The preparation script causes the ISO file to be loaded to a partition of the computing system 14, and also modifies a boot order of the computing system 14 such that the partition including the ISO file is loaded before other partitions on the computing system 14. The ISO file includes an ISO preparation script, new system content, and an ISO boot script. The ISO preparation script causes a new disk installer (e.g., an ISO installation file) to boot from volatile memory (e.g., random access memory (RAM)) of the computing system. The ISO boot script modifies a boot order on the basic input/output system (BIOS) of a target computing system. Further, the ISO boot script causes the computing system to power cycle.

The computing systems 14 may include a processor 50, a memory 52, a display 54, input/output components (I/O) 56, and communication circuitry 58 to enable the computing systems 14 to communicate with the disk reimaging system 12 and external storage components, such as cloud storage or the database 18. In some embodiments, the disk reimaging system 12 may store and/or execute an application in the memory 52 to be executed by the processor 50 that facilitates communication with the database 18. In some embodiments, the processor 30 may be one or more processors.

The communication circuitry 58 may include, for example, communication circuitry for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on.

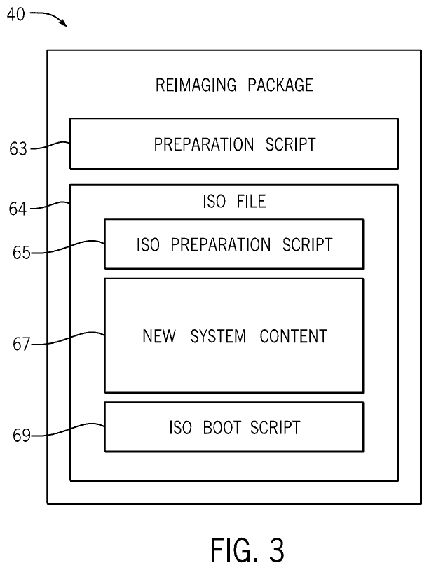

FIG. 3 shows a block diagram that illustrates the different scripts and software files of the reimaging package 40. As shown, the imaging package 40 includes the preparation script 63 and the ISO file 64. The ISO file 64 includes the ISO preparation script 65, the new system content 67, and the ISO boot script 69. As described herein, the preparation script 65 modifies a boot order of the computing system 14. In some embodiments, the preparation script 65 may execute or otherwise trigger based on a command or other indication to proceed with reimaging that is transmitted by the disk reimaging system 12. For example, it is presently recognized that it may be advantageous to delay reimaging of a computing system 14, such as when the computing system 14 is executing a task. As such, the communication between the disk reimaging system 12 and the computing system 14 may be utilized to control when reimaging occurs. As described herein, the preparation script 65 also causes the computing system 14 to reboot. Accordingly, the preparation script 63 may include generally similar scripts as the ISO boot script 69.

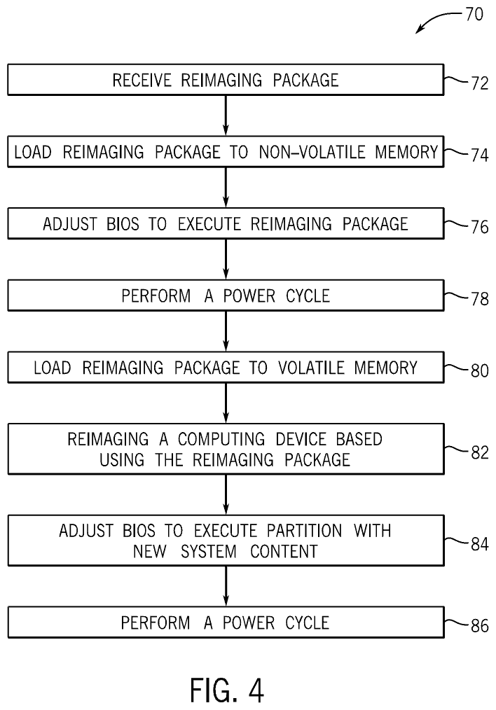

The memory 52 of the computing system 14 includes both volatile memory 60 (e.g., random access memory (RAM)) and non-volatile memory 62. As described in further detail herein, it may be advantageous to load portions of the reimaging package 40 to the non-volatile memory 62. With this in mind, FIG. 4 is a flow diagram of an example method 70 for updating the non-volatile memory 62 of the computing system 14. In general, certain process blocks performed in the method 70 may be performed by the processor 50 of the computing system 14. Moreover, certain process blocks described below may be performed in a different order than that illustrated, and, indeed, in some embodiments, certain process blocks may be skipped altogether.

At block 72, the processor 50 receives a reimaging package 40. For example, the processor 30 of the disk reimaging system 12 may transmit the reimaging package 40 to one or more computing systems 14. For example, the processor 30 of the disk reimaging system 12 may communicate with the computing systems 14 via the communication circuitry 38 of the disk reimaging system 12 and the communication circuitry 58 of the computing system 14.

At block 74, the processor 50 loads the reimaging package 40 (i.e., the ISO file) to the non-volatile memory 62. In particular, the processor 50 executes the preparation script 63 of the reimaging package 40. In some embodiments, the processor 50 may allocate a portion of the non-volatile memory 62 to the reimaging package 40. For example, the processor 50 may determine a size of the ISO file 64 and/or the reimaging package 40, and determine whether there is unused memory to load the ISO file 64 of the reimaging package 40. Additionally, or alternatively, the processor 50 may automatically load the ISO file 64 despite there being insufficient memory. As described herein, the processor 50 may load the ISO file 64 based on a command received from an external computing system, such as the disk reimaging system 12.

At block 76, the processor 50 adjusts the BIOS to execute the reimaging package. As described herein, the reimaging package 40 may include the preparation script 63 that generally modifies the boot order of the BIOS of the computing system 14.

In some embodiments, the processor 50 may perform an integrity check of the reimaging package 40 loaded to the non-volatile memory of the computing system 14. For example, the processor 50 may perform a check sums or other integrity check algorithms such as the Damm algorithm or the Luhn algorithm. It is presently recognized that it may be advantageous to perform the integrity check before the power cycle because after the power cycle, the reimaging package 40 may be loaded onto the volatile memory 60 of the computing system 14. As such, if an error in the reimaging were to occur (e.g., due to an error in the reimaging package 40, such as corrupt data), the reimaging package 40 may be lost. Accordingly, an operator may travel to the location of the computing system 14 to manually reimaging the computing system 14. In this way, performing the integrity check before the power cycle may improve the likelihood that the reimaging occurs successfully. If the processor 50 determines, via the integrity check, that the reimaging package 40 passes the integrity check, the processor 50 may communicate an indication (e.g., an alert, a visualization to display on the display 34 or another suitable display of a computing system) that the reimaging package 40 is acceptable to the disk reimaging system 12 and/or additional computing systems.

At block 78, the processor 50 performs a power cycle based on the instructions in the preparation script 63. To do so, the processor 50 may transmit a control signals that causes the computing system 14 to reboot. Accordingly, the computing system 14 restarts and the process 70 proceeds to block 80.

At block 80, the processor 50 loads the ISO file 64 to the volatile memory 60 of the computing system 14. As described herein, the processor 50 may run the scripts of the reimaging package 40 before running any other partitions or script on the computing system 14. Accordingly, the processor 50, by running the ISO preparation script 65, may cause the processor 50 to copy the ISO file 64 onto the new partition to the volatile memory 60 of the computing system 14.

At block 82, the processor 50 reimages the computing system 14 based on the reimaging package 40. In general, reimaging the computing system 14 includes loading the new system content 67 to the non-volatile memory 62 of the computing system 14.

At block 84, the processor 50 adjust the boot order (e.g., the BIOS) to execute the partition with the new system content 67. In generally, the processor 50 may perform block 84 in a generally similar manner as described with reference to block 76. Then, at block 86, the processor 50 performs a power cycle, thereby reimaging the disk of the computing system 14. In some embodiments, the processor 50 may communicate with an additional computing system 14 after the computing system 14 is reimaged (e.g., after rebooting). Accordingly, the process 70 updates the non-volatile memory with a new disk (e.g., a new partition) based on a reimaging package 40 transmitted by the disk reimaging system 12. In this way, the process may enable remote disk reimaging.

To further illustrate the process 70 described above, FIG. 4 shows a first time period 90, a second time period 92, a third time period 94, and a fourth time period 96 that correspond to the computing system 14 at different stages during reimaging using the reimaging package 40. It should be noted that the discussion below is described as being performed by the computing system 14, rather than the processor 50, for simplicity.

At the first time period 90, the computing system 14 includes an initial disk 98 within the non-volatile memory 62 of the computing system 14. As shown, the computing system 14 receives the reimaging package 40, which is transmitted by the disk reimaging system 12 or other suitable computing system capable of communicating with the computing system 14. In some embodiments, to accommodate the received reimaging package 40, the computing system 14 may allocate a portion of the initial disk 98 to the reimaging package 40.

At the second time period 92, the computing system 14 generates a new partition 100. Further, the computing system 14 loads the ISO file 64 to the new partition 100. After the new partition 100 is created, the preparation script 63 of the reimaging package 40 may modify a boot order of the BIOS of the computing system 14 such that scripts (e.g., the ISO file 64) on the new partition 100 are loaded before any scripts on the initial disk 98.

At the third time period 94, the computing system 14 has been reimaged using the reimaging package 40, and thus includes the new system content 67. Accordingly, the non-volatile memory 62 includes the new partition 102. At the fourth time period 96, the processor 50 has executed the ISO boot script 69 of the ISO file 64. As described herein, the new partition 102 may include no trace of the reimaging package 40 since the ISO file was loaded to the volatile memory 60, as compared to the non-volatile memory 62. Advantageously, the remote reimaging may provide the same results as if the reimaging were performed by an operator that is physical present.

One non-limiting example of an implementation of FIG. 4 is described below. Initially, the processor 30 may utilize a disk imaging or cloning program, such as CLONEZILLA, TRUE IMAGE, or NORTON GHOST, to generate the reimaging package 40. For example, the processor 30 may generate the reimaging package 40 using a postrun script that uses efibootmgr (e.g., for a Linux operating system) as the boot script to add the boot entry of the flashed disk and make it first in the boot sequence list. It should be noted that although the discussion is related to Linux operating systems, the disclosed techniques may be applied to other operating systems. As such, the reimaging package 40 may include other scripts as understood by one of ordinary skill in the art. Moreover, the boot script may modify an option for booting the installer script such that the installer script boots from RAM. Then, processor 30 may also include a reboot script in the reimaging package 40 such that the computing system 14 reboots after the boot script runs.

Accordingly, the processor 30 transmit the reimaging package 40 to the processor 30. The processor 30 then transfers the reimaging package 40 (e.g., including the installer script) to the processor 50 of the computing system 14. In some embodiments, the processor 50 of the computing system 14 may shrink a partition of the computing system 14. In some embodiments, the processor 50 may identify a partition or disk (e.g., an additional disk) that is not rootfs format, and generate the partition using a partition that is a storage partition or otherwise a non-rootfs partition. In this way, the processor 50 may avoid overwriting information or script that may be essential for start-up of the computing system. However, in some instances, the processor 50 may generate the partition using any partition, including a partition in rootfs format or otherwise utilized for non-storage purposes. In some instances, the new partition may be a fat 32 partition. After creating the new partition, the processor 50 may extract the reimaging package 40 to the new partition. Then, the processor 50 may execute a boot script of the preparation script (e.g., efibootmgr) to add an entry for the bootable path of the new partition's grub and reorder the boot sequence so the new partition is booted before the other partition.

After the boot script of the preparation script 63 is executed, the processor 50 may power cycle based on a reboot script of the preparation script 63. Based on the boot script modifying the boot sequence, the processor 50 may boot from the new partition that includes the ISO file 64. Accordingly, the ISO preparation script 65 of the ISO file 64 causes the processor 50 to copy the contents of the ISO file 64 onto the new partition to the volatile memory 60 of the computing system 14. The processor 50 then reimages the disk of the computing system 14. Further, the ISO boot script 69 of the ISO file 64 runs after the reimaging and modifies the boot order so that the reimaged disk (e.g., the new disk) runs first in the boot order. Further, the reboot script causes the processor 50 to reboot the computing system 14. After this reboot (e.g., the second reboot following the reimaging), a remote operator can have remote access of the computing system 14 to make any additional modifications.

Technical effects of the disclosure including remote reimaging of computing systems. For example, it is presently recognized that in some instances, computing systems may be in location that are not readily accessible and it may be costly to send an operator to the location to be physically present to reimage a disk. Accordingly, the disclosed techniques facilitate disk reimaging to avoid sending out an operator to perform the reimaging manually. Further, the disclosed techniques may not leave any trace that indicates the reimaging was performed, except the new system content that is loaded to the non-volatile memory.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

The subject matter described in detail above may be defined by one or more clauses, as set forth below.

A method includes receiving a reimaging package, wherein the reimaging package includes an identical storage image of optical media (ISO) file. The method also includes loading the reimaging package to a non-volatile memory of a computing system that stores a first disk in the volatile memory based on the reimaging package. Further, the method includes adjusting a firmware of the computing system based on the preparation script. Even further, the method includes performing a first power cycle of the computing system based on the reimaging package. Even further, the method includes loading the reimaging package to a volatile memory of the computing system after the power cycle. Further still, the method includes reimaging the computing system based on the ISO file loaded to the volatile memory of the computing system. Further still, the method includes adjusting the firmware of the computing system based on ISO file, subsequent to reimaging the computing system. Further still, the method includes performing a second power cycle of the computing system.

The method of any preceding claim, wherein loading the reimaging package to the non-volatile memory of the computing system comprises determining a portion of the non-volatile memory to allocate to the reimaging package; and loading the ISO file to the portion of the non-volatile memory.

The method of any preceding claim, comprising communicating with an additional computing system based on the reimaging package of the computing system.

The method of any preceding claim, further comprising performing an integrity check of the reimaging package loaded to the non-volatile memory of the computing system before performing the power cycle.

The method of any preceding claim, wherein performing the integrity check comprises performing a check sum operation.

The method of any preceding claim, comprising transmitting an alert based on the integrity check.

The method of any preceding claim, wherein the firmware is a basic input/output system (BIOS) of the computing system, wherein adjusting the firmware of the computing system comprises modifying a boot order of the BIOS.

The method of any preceding claim, wherein loading the ISO file to the non-volatile memory of the computing system that stores the first disk in the volatile memory comprises identifying an additional disk of a plurality of disks to load the reimaging package; and loading the reimaging package to the identified additional disk.

The method of any preceding claim, wherein the reimaging package includes a preparation script that is configured to adjust the firmware of the computing system.

A system includes a first computing system configured to transmit a reimaging package. The system also includes a second computing system comprising a processor, wherein the second computing system is configured to receive a reimaging package, wherein the reimaging package includes an identical storage image of optical media (ISO) file; load the reimaging package to a non-volatile memory of a computing system that stores a first disk in the volatile memory based on the reimaging package; adjust a firmware of the computing system based on the preparation script; perform a first power cycle of the computing system based on the reimaging package; load the reimaging package to a volatile memory of the computing system after the power cycle; reimage the computing system based on the ISO file loaded to the volatile memory of the computing system; adjust the firmware of the computing system based on ISO file, subsequent to reimaging the computing system; and perform a second power cycle of the computing system.

The system of any preceding claim, wherein the second computing system is configured to load the ISO file to the non-volatile memory by generating a new partition in the non-volatile memory.

The system of any preceding claim, wherein the second computing system is configured to adjust the firmware by adjusting a boot order of partitions that causes the new partition to run before an existing partition of the computing system.

The system of any preceding claim, wherein the ISO file comprises an ISO preparation script configured to cause the ISO file to be loaded to the non-volatile memory.

The system of any preceding claim, wherein the ISO file comprises an ISO boot script configured to cause the computing system to perform the second power cycle.

The system of any preceding claim, wherein the second computing system is configured to communicate with an additional computing system after updating the reimaging package.

A method includes generating an ISO file comprising an ISO preparation script, a new system content, and an ISO boot script. The method also includes generating a preparation script, wherein the preparation script is configured to modify a boot order of a computing system, and wherein the preparation script is configured to cause the computing system to load the ISO file to a non-volatile memory of the computing system. Further, the method includes assembling the ISO file and the preparation script to form a reimaging package.

The method of any preceding claim, further comprising transmitting the reimaging package to the computing system.

The method of any preceding claim, further comprising receiving an indication that the computing system is ready for reimaging, and triggering the reimaging based on the indication.

The method of any preceding claim, further comprising receiving an indication that the computing has been reimaged subsequent to receiving the indication.

The method of any preceding claim, wherein ISO preparation script is configured to cause the ISO file to be loaded to the non-volatile memory.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S. C. 112(f). However, for any claims containing elements designated in any other manner, it is intended that such elements are not to be interpreted under 35 U.S. C. 112(f).

1. A method, comprising:
receiving a reimaging package, wherein the reimaging package includes an identical storage image of optical media (ISO) file;
loading the reimaging package to a non-volatile memory of a computing system that stores a first disk in the volatile memory based on the reimaging package;
adjusting a firmware of the computing system based on the preparation script;
performing a first power cycle of the computing system based on the reimaging package;
loading the reimaging package to a volatile memory of the computing system after the power cycle;
reimaging the computing system based on the ISO file loaded to the volatile memory of the computing system;
adjusting the firmware of the computing system based on ISO file, subsequent to reimaging the computing system; and
performing a second power cycle of the computing system.

2. The method of claim 1, wherein loading the reimaging package to the non-volatile memory of the computing system comprises:
determining a portion of the non-volatile memory to allocate to the reimaging package; and
loading the ISO file to the portion of the non-volatile memory.

3. The method of claim 1, comprising communicating with an additional computing system based on the reimaging package of the computing system.

4. The method of claim 1, further comprising:
performing an integrity check of the reimaging package loaded to the non-volatile memory of the computing system before performing the power cycle.

5. The method of claim 4, wherein performing the integrity check comprises performing a check sum operation.

6. The method of claim 4, comprising transmitting an alert based on the integrity check.

7. The method of claim 1, wherein the firmware is a basic input/output system (BIOS) of the computing system, wherein adjusting the firmware of the computing system comprises modifying a boot order of the BIOS.

8. The method of claim 1, wherein loading the ISO file to the non-volatile memory of the computing system that stores the first disk in the volatile memory comprises:
identifying an additional disk of a plurality of disks to load the reimaging package; and
loading the reimaging package to the identified additional disk.

9. The method of claim 1, wherein the reimaging package includes a preparation script that is configured to adjust the firmware of the computing system.

10. A system comprising:
a first computing system configured to transmit a reimaging package;
a second computing system comprising a processor, wherein the second computing system is configured to:
receive a reimaging package, wherein the reimaging package includes an identical storage image of optical media (ISO) file;
load the reimaging package to a non-volatile memory of a computing system that stores a first disk in the volatile memory based on the reimaging package;
adjust a firmware of the computing system based on the preparation script;
perform a first power cycle of the computing system based on the reimaging package;
load the reimaging package to a volatile memory of the computing system after the power cycle;
reimage the computing system based on the ISO file loaded to the volatile memory of the computing system;
adjust the firmware of the computing system based on ISO file, subsequent to reimaging the computing system; and
perform a second power cycle of the computing system.

11. The system of claim 10, wherein the second computing system is configured to load the ISO file to the non-volatile memory by generating a new partition in the non-volatile memory.

12. The system of claim 11, wherein the second computing system is configured to adjust the firmware by adjusting a boot order of partitions that causes the new partition to run before an existing partition of the computing system.

13. The system of claim 10, wherein the ISO file comprises an ISO preparation script configured to cause the ISO file to be loaded to the non-volatile memory.

14. The system of claim 10, wherein the ISO file comprises an ISO boot script configured to cause the computing system to perform the second power cycle.

15. The system of claim 10, wherein the second computing system is configured to communicate with an additional computing system after updating the reimaging package.

16. A method, comprising:
generating an ISO file comprising an ISO preparation script, a new system content, and an ISO boot script;
generating a preparation script, wherein the preparation script is configured to modify a boot order of a computing system, and wherein the preparation script is configured to cause the computing system to load the ISO file to a non-volatile memory of the computing system; and
assembling the ISO file and the preparation script to form a reimaging package.

17. The method of claim 16, further comprising transmitting the reimaging package to the computing system.

18. The method of claim 17, further comprising receiving an indication that the computing system is ready for reimaging, and triggering the reimaging based on the indication.

19. The method of claim 18, further comprising receiving an indication that the computing has been reimaged subsequent to receiving the indication.

20. The method of claim 16, wherein ISO preparation script is configured to cause the ISO file to be loaded to the non-volatile memory.
